(19) United States
(12) Patent Application Publication
(10) Pub. No.: US 2010/0095911 A1
(43) Pub. Date: Apr. 22, 2010

(54) HEAT TRANSPORT MEDIUM

(75) Inventors: Yoshiyuki MORITA, Wako-shi (JP); Ayako OMORI, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/972,126

(22) Filed: Jan. 10, 2008

(30) Foreign Application Priority Data
Jan. 11, 2007 (JP) 2007-003388
Nov. 8, 2007 (JP) 2007-290559

(51) Int. Cl. C09K 5/00; F01P 5/10

(52) U.S. Cl. 123/41.44; 252/79; 977/742

(57) ABSTRACT

The present invention relates to a heat transport medium used in a heat exchanger; wherein the heat transport medium improves heat conductivity without increasing kinetic viscosity by stably dispersing carbon nanotubes in a base liquid; especially water and ethylene glycol. Carbon nanotubes are stably dispersed in the base liquid by including sodium carboxyl methyl cellulose which has average molecular weight given by GPC measuring method is 6000-30000. Therefore, the heat transport medium improves heat conductivity without increasing kinetic viscosity. pH can be kept in proper range. Furthermore, a chemical reaction by the dispersant is prevented.

### TECHNICAL FIELD

The present invention relates to heat transport medium for use in heat exchanger; wherein the heat transport medium improves heat conductivity without increasing kinetic viscosity by stably dispersing carbon nanotubes in a base liquid; especially water and ethylene glycol.

### BACKGROUND OF THE INVENTION

In a method for improving the heat conductivity of heat transport medium, it is known to mix liquid with metal system nanometric particles whose diameter is on a nanometer order. See J. Heat Transfer 121, pp. 280-289 (1999). For a liquid including metal system nanometric particles, metal oxides which are added to a base liquid include, for example Al₂O₃, CuO, TiO₂, Fe₂O₃, whose diameter is less than or equal to 100 nm. Further, an interfacial active agent is used; for example dodecyl sodium sulfate, sodium polyacrylate, to keep stable dispersal.

However, metal system nanometric particles of 1-10 wt % relative to the heat transport medium need to be added to improve the heat conductivity of liquid, and adding a large amount of metal system nanometric particles increases the kinetic viscosity of the liquid severely. The increase of the kinetic viscosity of the liquid increases the energy consumption of the pump to circulate the fluid, and an increase in friction resistance occurs. Therefore, this increase causes some problems, for example heat exchange efficiency and the amount of heat release decrease, and thus prevents improving of heat conductivity.

Another liquid is known. It comprises solubilized carbon nanotubes in a base liquid, instead of metal system nanometric particles. In detail, in this technology, carbon nanotubes are solubilized in a base liquid by acid treatment on the surface of carbon nanotubes. See Japanese Patent Application Publications JP2003-95624, JP2003-300715, JP2003-300716, JP2004-168570 and JP2004-216516.

However, under this technology, adding a small amount of carbon nanotubes into the base liquid causes a decrease in pH to 5-6 because of the acid treatment on the surface of carbon nanotubes. Therefore, the liquid is cauterant and there is a problem that it is necessary to provide or maintain acid-resistance for the system with the heat transport medium.

Another liquid is also known. The solubilization technology of carbon nanotubes by a basic polymer comprising an amino base or a fluorine polymer as dispersant is shown. See Japanese Patent Application Publication JP2004-261713.

However, this heat transport medium also comprises general anti-corrosion material to prevent corrosion of metal pipework parts making up the flow passage. Therefore, there is a possibility that the dispersant and anti-corrosion material react chemically and cause problems, for example deposition, decomposition, transmutation and formation of a supernatant. Further, these polymers have poor heat resistance in view of the application for heat transport medium because they can decompose or burn under 200° C.

### SUMMARY OF THE INVENTION

It is therefore an object of the present invention to provide a heat transport medium which improves heat conductivity while preventing the increase in kinetic viscosity.

It is another object of the present invention to provide a heat transport medium with the pH kept in the appropriate range.

It is another object of the present invention to provide a heat transport medium which prevents chemical reaction with a dispersant.

In accordance with a first aspect of the present invention, there is provided a heat transport medium comprising a base liquid, carbon nanotubes and sodium carboxyl methyl cellulose which has average molecular weight of 6000-30000 by the GPC measuring method, wherein said carbon nanotubes and said sodium carboxyl methyl cellulose are dispersed in the base liquid.

Sodium carboxyl methyl cellulose whose average molecular weight is greater than or equal to 6000 by the GPC measuring method is favorable because it is easy to produce. Sodium carboxyl methyl cellulose whose average molecular weight is less than or equal to 30000 by the GPC measuring method is favorable because kinetic viscosity of the liquid is prevented from increasing.

In accordance with a second aspect of the present invention, there is provided a heat transport medium, wherein the carbon nanotubes are 0.1-10 wt % relative to the heat transport medium and the sodium carboxyl methyl cellulose is 0.1-10 wt % relative to the heat transport medium.

Content of carbon nanotubes of greater than or equal to 0.1 wt % is favorable because an improvement is available without an increase in the kinetic viscosity. Content of carbon nanotubes of less than or equal to 10 wt % is favorable because an increase in the kinetic viscosity is prevented. Content of sodium carboxyl methyl cellulose of greater than or equal to 0.1 wt % is favorable because the dispersion of carbon nanotubes is good. Content of sodium carboxyl methyl cellulose of less than or equal to 10 wt % is favorable because an increase in the kinetic viscosity is prevented.

In accordance with a third aspect of the present invention, there is provided a heat transport medium having a kinetic viscosity of less than or equal to 20 mm²/sec under 25° C. and of less than or equal to 10 mm²/sec under 45° C.

The kinetic viscosity of less than or equal to 20 mm²/sec under 25° C. and of less than or equal to 10 mm²/sec under 45° C. is favorable because the energy consumption of circulation is decreased and the heat exchange efficiency is increased.

In accordance with a fourth aspect of the present invention, there is provided a heat transport medium, wherein said carbon nanotubes and said sodium carboxyl methyl cellulose are dispersed stably.

This product enables stable heat transport.

In accordance with a fifth aspect of the present invention, there is provided heat transport medium used for an cooling internal combustion engine in a vehicle.

In this aspect, the whole system could be downsized because an equivalent heat exchange efficiency is available with a lesser amount of heat transport medium.

In accordance with a sixth aspect of the present invention, there is a method for producing a heat transport medium including the steps of: sending a base liquid with carbon nanotubes and a dispersant from a container to an ultrasonic processor, dispersing the base liquid with the carbon nanotubes and the dispersant by the ultrasonic processor, and returning the dispersed base liquid, carbon nanotubes and dispersant to the container, wherein the above steps are repeated continuously.

### BRIEF DESCRIPTION OF THE DRAWINGS

FIG. 1 is a diagram showing a circulating treatment system for producing a heat transport medium in this invention;

FIG. 2 is a diagram showing equipment measuring an amount of heat release for a heat transport medium; and

FIG. 3 is a graph showing an amount of heat release in relation to an amount of flow rate for heat transport medium.

### DETAILED DESCRIPTION OF THE INVENTION

In the following paragraphs, some preferred embodiments of the invention will be described by way of example and not limitation. It should be understood based on this disclosure that various other modifications can be made by those in the art based on these illustrated embodiments.

In this invention, the heat transport medium comprises base liquid, carbon nanotubes, and finite sodium carboxyl methyl cellulose. The finite sodium carboxyl methyl cellulose has a function dispersing carbon nanotubes in base liquid. The details of each element are as follows.

In this invention, H₂O; alcohols, for example methanol, ethanol, propanol, butanol, pentanol, hexanol and heptanol; glycols, for example ethylene glycol and propylene glycol; and mixture of these are used as the base liquid.

In this invention, multilayer carbon nanotubes; bilayer carbon nanotubes; single layer carbon nanotubes; fullerene, for example at least one from the group of C60, C70, C76, C78, C82, C84, C90, C96; carbon nanocoils; and carbon fibers are used as carbon nanotubes. The surface of the carbon nanotubes can be modified in this invention.

In defining sodium carboxyl methyl cellulose of this invention, it is essential that average molecular weight is 6000-30000 by the GPC measuring method because kinetic viscosity of the heat transport medium is low and the carbon nanotubes disperse stably. Moreover, it is more favorable that the average molecular weight is 6000-28000. Sodium carboxyl methyl cellulose whose average molecular weight by the GPC measuring method is greater than or equal to 6000 is favorable because it is easy to produce. Sodium carboxyl methyl cellulose whose average molecular weight by the GPC measuring method is less than or equal to 30000 is favorable because kinetic viscosity of the liquid is prevented from increasing.

In the sodium carboxyl methyl cellulose of this invention, it is favorable that the substitution degree, which is called the DS degree, is greater than or equal to 0.1 because the sodium carboxyl methyl cellulose can solubilize easily. With sodium carboxyl methyl cellulose, carbon nanotubes can be dispersed without a chemical modification treatment, for example by adding a functional group to a surface of the carbon nanotubes. Therefore, pH of heat transport medium can be kept in the range of 6.5-9.0 and damage to the equipment is decreased.

In the sodium carboxyl methyl cellulose of this invention, it is favorable that the allowable temperature limit is greater than or equal to 250° C.

Content of carbon nanotubes in this invention of greater than or equal to 0.1 wt % is favorable because the improvement effect is available without an increase in the kinetic viscosity. Content of carbon nanotubes of less than or equal to 10 wt % is favorable because an increase in the kinetic viscosity is prevented. Content of sodium carboxyl methyl cellulose of greater than or equal to 0.1 wt % is favorable because the dispersion of carbon nanotubes is good. Content of sodium carboxyl methyl cellulose of less than or equal to 10 wt % is favorable because an increase in the kinetic viscosity is prevented.

Sodium carboxyl methyl cellulose and other celluloses, which are efficient to disperse carbon nanotubes, are used as the dispersant in this invention. Other celluloses include at least cellulose ether, for example at least one from the group of dextrin, cyclodextrin, methylcellulose, ethylcellulose, hydroxyethylcellulose, hydroxypropylcellulose, hydroxypropylmethylcellulose, hydroxypropylmethylcellulosephthalate, carboxymethylcellulose; cellulose ester, for example cellulose acetatephthalate; cellulose ether ester; methoxylation pectine; carboxymethylation starch; and chitosan.

In the heat transport medium of the present invention, The kinetic viscosity of less than or equal to 20 mm²/sec under 25° C. and less than or equal to 10 mm²/sec under 45° C. is favorable, and the kinetic viscosity 0.9-20 mm²/sec under 25° C. and 0.5-10 mm²/sec under 45° C. is more favorable. The reason is that the energy consumption of circulation is decreased and the heat exchange efficiency is increased.

In this invention, the heat transport medium can comprise anti-corrosion material. This anti-corrosion material can include at least one from the group of phosphoric acid including orthophosphoric acid, pyrophosphoric acid, hexametaphosphoric acid and tripolyphosphoric acid; aliphatic carboxylic acid including at least one from the group of pentane acid, hexane acid, heptane acid, octane acid, nonane acid, decane acid, 2-ethylhexane acid, adipic acid, suberic acid, azelaic acid, sebacic acid, undecanoic acid, and dodecane dioic acid; and aromatic carboxylic acid including at least one from the group of acidum benzoicum, toluic acid, p-t-butyl benzoic acid, phthalic acid, p-methoxybenzoic acid, and cinnamic acid. The salts of these acid can be used, and sodium salt and potassium salts are favorable. Moreover, triazole including at least one from the group of benzotriazole, merbenzotriazole, cycrobenzotriazole and 4-phenyl-1,2,3-triazole; thiazole, for example mercapto benzothiazole; silicate incluing at least one from the group of metasilicic acid and liquid glass (Na₂O/XSiO₃ X=0.5-3.3); nitrate including at least one from the group of sodium nitrate and potassium nitrate; nitrite including at least one from the group of sodium nitrite and potassium nitrite; borate including at least one from the group of sodium tetraborate and potassium tetraborate; molybdate including at least one from the group of sodium molybdate, potassium molybdate, and ammonium molybdate; amine salt including at least one from the group of monoethanolamin, diethanolamin, triethanolamin, monoisopropanolamin, diisopropanolamin and triisopropanolamin also are used for the anti-corrosion material.

In this invention, there is a method for producing a heat transport medium including the steps of: sending a base liquid with carbon nanotubes and a dispersant from a container to an ultrasonic processor, dispersing the base liquid with the carbon nanotubes and the dispersant by the ultrasonic processor, and returning the dispersed base liquid, carbon nanotubes and dispersant to the container, wherein the above steps are repeated continuously.

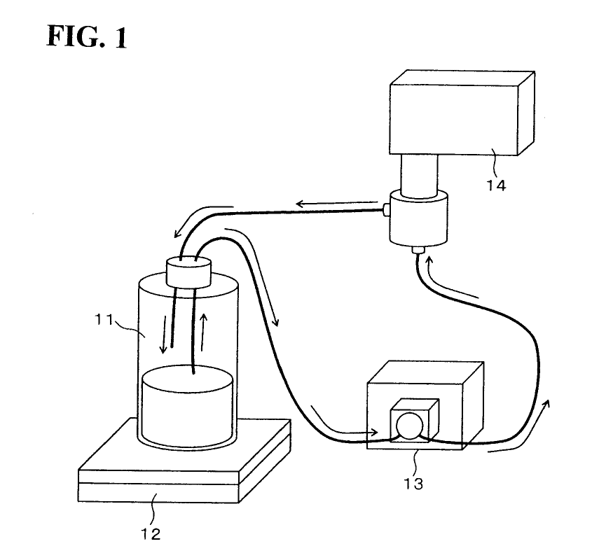

In detail, the circulating treatment system shown in FIG. 1 can be used. The circulating treatment system in FIG. 1 comprises a vial container 11, wherein base liquid having carbon nanotubes and sodium carboxyl methyl cellulose is kept, a magnetic stirrer 12, a pump 13 and an ultrasonic processor 14 in this invention. The magnetic stirrer 12 stirs the base liquid in the vial container 11 and a part of base liquid is circulated in the circulating treatment system by the pump 13. Moreover, the ultrasonic processor 14 arbitrarily irradiates the base liquid which is around the ultrasonic processor 14 with ultrasonic treatment. Therefore, the carbon nanotubes are dispersed in the base liquid.

The heat transport medium can be applied to at least a cooling medium for internal combustion engines, fuel cell unit, computer circuit, central processing unit (CPU), atomic pile and steam-power generation; heat transport medium for cooling and heating system, heat storage system and hot water and boiler system; electrolyte for dye sensitized type solar cell; electrically-conductive coating; electromagnetic wave absorption coating; water repellency coating; and lubricating film coating.

### EXAMPLES

### 1. Producing the Heat Transport Medium

### Example 1

Extra-pure water is filled up in the vial container after determining an exact amount of the extra-pure water. Extra-pure water is provided by an ultrapure water production system (MILLI-Q-Labo produced by Nihon Millipore K.K.). As shown in Table. 1, 4 wt % of sodium carboxyl methyl cellulose (Average molecular weight 6000, Sun-Rose, APP-84, produced by Nippon Paper Chemicals Co., Ltd) is added into the ultrapure water as a dispersant after determining an exact amount of the sodium carboxyl methyl cellulose. Mixed liquid is stirred by the magnetic stirrer (CERAMAG-Mid, produced by IKA Works, Inc.) for 60-120 minutes.

After that, 1.37 wt % of the carbon nanotubes (Multiwall carbon nanotubes, 636495-50G, produced by Sigma Aldrich Corp.) is added into the mixed liquid as a dispersant after determining an exact amount of the carbon nanotubes as shown in Table. 1. The mixed liquid is stirred at 1200 rpm by the magnetic stirrer (CERAMAG-Mid, produced by IKA Works, Inc.) for 1-2 hours as the pre-stir at room temperature (around 25° C.)

After that, the vial container 11 containing the mixed liquid is connected to the circulating treatment system which comprises an ultrasonic processor 14 (UP400S unit, output 400W, and G22K flow cell, produced by Hielscher urtrasonic gmbH) shown in FIG. 1. The mixed liquid is circulated at 300 ml per a minute by the pump 13 (ConsoleDrive-7520-40 and EasyLoad7518-00 produced by MasterFlex AG) and is irradiated with ultrasonic treatment by the ultrasonic processor 14 while continuing to stir at 1200 rpm by the magnetic stirrer 12. The circulation and the ultrasonic irradiation treatment time is 3-5 hours per 1000 ml.

Moreover, the mixed liquid is centrifuged at relative centrifugal force of 700G for 30 minutes by the centrifuge (himac-CT4D, produced by Hitachi, Ltd.) and the supernatant solution of the mixed liquid is picked out with a dropper since the deposition includes insoluble carbon nanotubes. Thus, the heat transport medium of example 1 is provided.

### Example 2

1.37 wt % of carbon nanotubes (Multiwall carbon nanotubes, 636495-50G, produced by Sigma Aldrich Corp.) in example 1 is replaced with 1.09 wt % of the carbon nanotubes (Single-Triple mixture carbon nanotubes, XD-34429-A, produced by CNI) as shown in table 1. The other processes for production of the heat transport medium of example 2 are the same as that of example 1.

### Example 3

1.37 wt % of carbon nanotubes (Multiwall carbon nanotubes, 636495-50G, produced by Sigma Aldrich Corp.) in example 1 is replaced with 0.97 wt % of the carbon nanotubes (Singlewall carbon nanotubes, XB-0914, produced by CNI) as shown in table 1. The other processes for production of the heat transport medium of example 3 are the same as that of example 1.

### Example 4

The amount of carbon nanotubes (Multiwall carbon nanotubes, 636495-50G, produced by Sigma Aldrich Corp.) in example 1 is changed to 1.33 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 15000, Cellogen, 5A, produced by Dai-ichi Kogyo Seiyaku Co., Ltd.) as shown in table 1. The other processes for production of the heat transport medium of example 4 are the same as that of example 1.

### Example 5

The amount of carbon nanotubes (Single-Triple mixture carbon nanotubes, XD-34429-A, produced by CNI) in example 2 is changed to 1.02 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 15000, Cellogen, 5A, produced by Dai-ichi Kogyo Seiyaku Co., Ltd.) as shown in table 1. The other processes for production of the heat transport medium of example 5 are the same as that of example 2.

### Example 6

The amount of carbon nanotubes (Singlewall carbon nanotubes, XB-0914, produced by CNI) in example 3 is changed to 0.96 wt % and the sodium carboxyl methyl cellulose (average molecular weight 6000, Sun-Rose, APP-84, produced by Nippon paper chemicals Co., Ltd) is replaced with the sodium carboxyl methyl cellulose (average molecular weight 15000, Cellogen, 5A, produced by Dai-ichi Kogyo Seiyaku Co., Ltd.) as shown in table 1. The other processes for production of the heat transport medium of example 6 are the same as that of example 3.

### Example 7

The amount of carbon nanotubes (Multiwall carbon nanotubes, 636495-50G, produced by Sigma Aldrich Corp.) in example 1 is changed to 1.32 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 25000, CMC Daicel, 1102, produced by Daicel chemical industries, Ltd.) as shown in table 1. The other processes for production of the heat transport medium of example 7 are the same as that of example 1.

### Example 8

The sodium carboxyl methyl cellulose (average molecular weight 6000, Sun-Rose, APP-84, produced by Nippon Paper Chemicals Co., Ltd) in example 2 is replaced with the sodium carboxyl methyl cellulose (average molecular weight 25000, CMC Daicel, 1102, produced by Daicel chemical industries, Ltd.) as shown in table 1. The other processes for production of the heat transport medium of example 8 are the same as that of example 2.

### Example 9

The amount of carbon nanotubes (Singlewall carbon nanotubes, XB-0914, produced by CNI) in example 3 is changed to 0.88 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 25000, CMC Daicel, 1102, produced by Daicel chemical industries, Ltd.) as shown in table 1. The other processes for production of the heat transport medium of example 9 are the same as that of example 3.

### Example 10

The amount of carbon nanotubes (Multiwall carbon nanotubes, 636495-50G, produced by Sigma Aldrich Corp.) in example 1 is changed to 1.32 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 28000, Cellogen, 6A, produced by Dai-ichi Kogyo Seiyaku Co., Ltd.) as shown in table 1. The other processes for production of the heat transport medium of example 10 are the same as that of example 1.

### Example 11

The amount of carbon nanotubes (Single-Triple mixture carbon nanotubes, XD-34429-A, produced by CNI) in example 11 is changed to 1.08 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 28000, Cellogen, 6A, produced by Dai-ichi Kogyo Seiyaku Co., Ltd.) as shown in table 1. The other processes for production of the heat transport medium of example 11 are the same as that of example 2.

### Example 12

The amount of carbon nanotubes (Singlewall carbon nanotubes, XB-0914, produced by CNI) in example 3 is changed to 0.99 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 28000, Cellogen, 6A, produced by Dai-ichi Kogyo Seiyaku Co., Ltd.) as shown in table 1. The other processes for production of the heat transport medium of example 12 are the same as that of example 3.

### Example 13

The amount of carbon nanotubes (Multiwall carbon nanotubes, 636495-50G, produced by Sigma Aldrich Corp.) in example 1 is changed to 1.27 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 30000, Cellogen, 7A, produced by Dai-ichi Kogyo Seiyaku Co., Ltd.) as shown in table 1. The other processes for production of the heat transport medium of example 13 are the same as that of example 1.

### Example 14

The amount of carbon nanotubes (Single-Triple mixture carbon nanotubes, XD-34429-A, produced by CNI) in example 14 is changed to 1.06 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 30000, Cellogen, 7A, produced by Dai-ichi Kogyo Seiyaku Co., Ltd.) as shown in table 1. The other processes for production the heat transport medium of example 14 are the same as that of example 2.

### Example 15

The amount of carbon nanotubes (Singlewall carbon nanotubes, XB-0914, produced by CNI) in example 3 is changed to 0.92 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 30000, Cellogen, 7A, produced by Dai-ichi Kogyo Seiyaku Co., Ltd.) as shown in table 1. The other processes for production of the heat transport medium of example 15 are the same as that of example 3.

### Example 16

The amount of carbon nanotubes (Multiwall carbon nanotubes, 636495-50G, produced by Sigma Aldrich Corp.) in example 1 is changed to 9.92 wt %. The other processes for production of the heat transport medium of example 16 are the same as that of example 1.

### Example 17

The amount of carbon nanotubes (Multiwall carbon nanotubes, 636495-50G, produced by Sigma Aldrich Corp.) in example 1 is changed to 12.6 wt %. The other processes for production of the heat transport medium of example 17 are the same as that of example 1.

### Comparative Example 1

Extra-pure water provided by an ultrapure water production system (MILLI-Q-Labo produced by Nihon Millipore K.K.) is the heat transport medium of comparative example 1.

### Comparative Example 2

1.37 wt % of carbon nanotubes (Multiwall carbon nanotubes, 636495-50G, produced by Sigma Aldrich Corp.) in example 1 is replaced with 10.00 wt % of the Al₂O₃ nanoparticle (AEROXIDE-Alu-C-805, produced by Nippon Aerosil Co., Ltd.) and the sodium carboxyl methyl cellulose is replaced with the sodium polycarboxylate as shown in table 1. The other processes for production of the heat transport medium of comparative example 2 are the same as that of example 1.

### Comparative Example 3

The amount of carbon nanotubes (Multiwall carbon nanotubes, 636495-50G, produced by Sigma Aldrich Corp.) in example 1 is changed to 0.94 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 90000, 9273-100G, produced by Sigma Aldrich Corp.) as shown in table 1. The other processes for production of the heat transport medium of comparative example 3 are the same as that of example 1.

### Comparative Example 4

The amount of carbon nanotubes (Single-Triple mixture carbon nanotubes, XD-34429-A, produced by CNI) in example 2 is changed to 0.87 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 90000, 9273-100G, produced by Sigma Aldrich Corp.) as shown in table 1. The other processes for production of the heat transport medium of comparative example 4 are the same as that of example 2.

### Comparative Example 5

The amount of carbon nanotubes (Singlewall carbon nanotubes, XB-0914, produced by CNI) in example 3 is changed to 0.66 wt % and the sodium carboxyl methyl cellulose (average molecular weight 6000, Sun-Rose, APP-84, produced by Nippon Paper Chemicals Co., Ltd) is replaced with the sodium carboxyl methyl cellulose (average molecular weight 90000, 9273-100G, produced by Sigma Aldrich Corp.) as shown in table 1. The other processes for production of the heat transport medium of comparative example 5 are the same as that of example 3.

### Comparative Example 6

The amount of carbon nanotubes (Multiwall carbon nanotubes, 636495-50G, produced by Sigma Aldrich Corp.) in example 6 is changed to 0.01 wt % and the sodium carboxyl methyl cellulose is not added as shown in table 1. The other processes for production of the heat transport medium of comparative example 6 are the same as that of example 1.

TABLE 1

| | | | [symbol] rage molecular | | |
|---|---|---|---|---|---|
| | | [symbol] centration of | ight of sodium | [symbol] centration of | degree of |
| | carbon | [symbol] bon nanotube | [symbol] boxyl methyl | [symbol] lium carboxyl | [symbol] ium carboxyl |
| | nanotube | [symbol] %) | [symbol] lulose | [symbol] thyl cellulose | [symbol] thyl cellulose |
| example 1 | MW | 1.37 | 6000 | 4 | 0.70 |
| example 2 | SW mix | 1.09 | 6000 | 4 | 0.70 |
| example 3 | SW | 0.97 | 6000 | 4 | 0.70 |
| example 4 | MW | 1.33 | 15000 | 4 | 0.75 |
| example 5 | SW mix | 1.02 | 15000 | 4 | 0.75 |
| example 6 | SW | 0.96 | 15000 | 4 | 0.75 |
| example 7 | MW | 1.32 | 25000 | 4 | 0.75 |
| example 8 | SW mix | 1.09 | 25000 | 4 | 0.75 |
| example 9 | SW | 0.88 | 25000 | 4 | 0.75 |
| example 10 | MW | 1.32 | 28000 | 4 | 0.75 |
| example 11 | SW mix | 1.08 | 28000 | 4 | 0.75 |
| example 12 | SW | 0.99 | 28000 | 4 | 0.75 |
| example 13 | MW | 1.27 | 30000 | 4 | 0.75 |
| example 14 | SW mix | 1.06 | 30000 | 4 | 0.75 |
| example 15 | SW | 0.92 | 30000 | 4 | 0.75 |
| example 16 | MW | 9.92 | 6000 | 9 | 0.70 |
| example 17 | MW | 12.60 | 6000 | 12 | 0.70 |
| comparative | — | 0.00 | — | 0 | — |
| example 1 | | | | | |
| comparative | Al₂O₃ | 10.00 | sodium | 4 | — |
| example 2 | no-particle | | [symbol] olycarboxylate | | |
| comparative | MW | 0.94 | 9000 | 4 | 0.70 |
| example 3 | | | | | |
| comparative | SW mix | 0.87 | 9000 | 4 | 0.70 |
| example 4 | | | | | |
| comparative | SW | 0.66 | 9000 | 4 | 0.70 |
| example 5 | | | | | |
| comparative | MW | 0.01 | — | 0 | — |
| example 6 | | | | | |

[symbol]

indicates data missing or illegible when filed

In table 1, MW, SW mix and SW mean Multiwall carbon nanotubes (636495-50G, produced by Sigma Aldrich Corp.), Single-Triple mixture carbon nanotubes (XD-34429-A, produced by CNI) and Singlewall carbon nanotubes (XB-0914, produced by CNI), respectively.

### 2. Measurement

For the heat transport medium provided thorough above process, pH, density, specific heat, thermal diffusivity, heat conductivity and kinetic viscosity are measured and it is confirmed by a visual check whether there is deposition or not. Those results are shown in Table 2.

pH is measured with a pH meter (Handy type pH meter, Cyberscan PH310, produced by Eutech Instruments Ltd.). Density is measured with a density bottle (catalog No. 03-247, produced by Fischer Scientific Inc.). Specific heat is measured with the DSC (DSC-220C, produced by SEIKO instruments Inc.). Thermal diffusivity is measured by the TWA method with ai-Phase-αkai, produced by ai-Phase Co., Ltd. and Nano flash LFA447 produced by Netzsch. Heat conductivity is measured by the following calculation:

λ=α*Cp*D

λ: heat conductivity
α: thermal diffusivity
Cp: specific heat
D: density

Kinetic viscosity is measured with kinetic viscosity measuring equipment (Kinematic Viscosity Bath, produced by Tanaka Scientific Instrument Co., Ltd) and the viscometer (Uberote viscometer, 2613-0001˜2613-100, produced by Shibata scientific technology LTD.)

TABLE 2

| | | | | | | kinetic | kinetic | |
|---|---|---|---|---|---|---|---|---|
| | | | | | | viscosity | viscosity | |
| | | | specific | thermal | heat | under | under | |
| | | density | heat | diffusivity | conductivity | 25° C. | 40° C. | existence of |
| | pH | (g/cm³) | (kJ/kgK) | (cm²/sec) | (W/mk) | (mm²/sec) | (mm²/sec) | conductivity |
| example 1 | 7.7 | 1.10 | 4.10 | 1.64 | 0.74 | 6.22 | 5.03 | No |
| example 2 | 7.8 | 1.10 | 4.10 | 1.66 | 0.75 | 6.01 | 4.81 | No |
| example 3 | 7.7 | 1.10 | 4.10 | 1.66 | 0.75 | 5.97 | 4.73 | No |
| example 4 | 7.6 | 1.10 | 4.10 | 1.65 | 0.74 | 7.12 | 5.88 | No |
| example 5 | 7.6 | 1.10 | 4.10 | 1.65 | 0.74 | 6.93 | 5.52 | No |
| example 6 | 7.7 | 1.10 | 4.10 | 1.66 | 0.75 | 6.77 | 5.48 | No |
| example 7 | 7.8 | 1.10 | 4.10 | 1.66 | 0.75 | 7.78 | 6.43 | No |
| example 8 | 7.8 | 1.10 | 4.10 | 1.64 | 0.75 | 7.44 | 6.01 | No |
| example 9 | 7.8 | 1.10 | 4.10 | 1.66 | 0.75 | 7.15 | 5.69 | No |
| example 10 | 7.8 | 1.10 | 4.10 | 1.66 | 0.75 | 7.93 | 6.70 | No |
| example 11 | 7.9 | 1.10 | 4.10 | 1.64 | 0.75 | 7.63 | 6.35 | No |
| example 12 | 7.7 | 1.10 | 4.10 | 1.64 | 0.75 | 7.22 | 6.11 | No |
| example 13 | 7.8 | 1.10 | 4.10 | 1.65 | 0.75 | 8.01 | 6.89 | No |
| example 14 | 7.7 | 1.10 | 4.10 | 1.64 | 0.75 | 7.71 | 6.64 | No |
| example 15 | 7.7 | 1.10 | 4.10 | 1.66 | 0.75 | 7.44 | 6.36 | No |
| example 16 | 6.8 | 1.20 | 4.10 | 2.21 | 0.70 | 16.22 | 9.36 | No |
| example 17 | 6.9 | 1.20 | 4.10 | 2.41 | 0.70 | 19.11 | 12.40 | No |
| comparative | 6.9 | 1.00 | 4.20 | 1.44 | — | 0.89 | 0.68 | No |
| example 1 | | | | | | | | |
| comparative | 8.9 | 1.10 | 4.10 | 1.52 | — | 11.73 | 9.42 | No |
| example 2 | | | | | | | | |
| comparative | 8.1 | 1.10 | 4.10 | 1.60 | 0.70 | 8.61 | 6.23 | No |
| example 3 | | | | | | | | |
| comparative | 7.9 | 1.10 | 4.10 | 1.64 | 0.70 | 9.24 | 6.91 | No |
| example 4 | | | | | | | | |
| comparative | 7.9 | 1.10 | 4.10 | 1.63 | 0.70 | 9.65 | 7.31 | No |
| example 5 | | | | | | | | |
| comparative | 7.3 | 1.00 | 4.17 | 1.45 | — | 0.91 | 9.42 | Existence |
| example 6 | | | | | | | | |

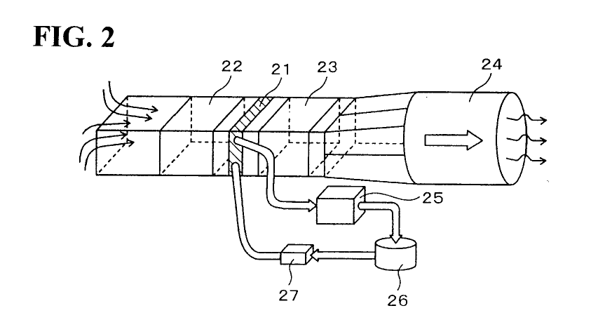

For the heat transport medium of Example 1, Example 2 and Comparative example 1, the amount of heat release is measured with the measuring equipment shown in FIG. 2. In FIG. 2, the measuring equipment for measuring the amount of heat release comprises the heat exchanger 21; the air channel 22, 23 which is made of aluminum and comprises a current plate covered with an adiabatic sheet (K-FLEX25 mm ST grade, produced by IK Insulation); and the fan 24 (Jet suifan SFJ-300-1, Produced by SUIDEN CO., LTD.) The air channel 22 is set upstream of the heat exchanger 21 and the air channel 23 is set downstream of the heat exchanger 21. The fan 24 is set downstream of the air channel 23. The heat exchanger 21 contains eighteen cartridge heaters (HLC1305, produced by Hakko Electric Machine Works Co., Ltd.) covered with adiabatic sheets (K-FLEX25 mm ST grade, produced by IK Insulation). The heating tank 25 is covered with an adiabatic sheet (K-FLEX25 mm ST grade, produced by IK Insulation). The circulating pump 26 and the flowmeter 27 are connected to the heat exchanger 21, thus the heat transport medium circulates and is heated.

The amount of the heat release (Q) is calculated from ΔT, Cp, D, V and the below formula. ΔT is difference between the temperature of heat transport medium inflowing the heat exchanger 21 and the temperature of transport medium outflowing the heat exchanger 21. Cp and D are the specific heat and the density of the heat transport medium respectively. V is the flow rate measured with the flowmeter 27. The result of Q is shown in Table 3.

Q=ΔT*Cp*D*V

The following facts are known from the results in Table 2:

The dispersion of the carbon nanotubes and the sodium carboxyl methyl cellulose, wherein the average molecular weight of the sodium carboxyl methyl cellulose is 6000-30000, in the base liquid increases the heat conductivity of the heat transport medium.

Secondly, the carbon nanotubes are insoluble in the base liquid without the sodium carboxyl methyl cellulose and does not increase the heat conductivity of the heat transport medium.

Above facts are known from the comparison of examples 1-17 and comparative examples 1 and 6.

Thirdly, the sodium carboxyl methyl cellulose, wherein the average molecular weight of the sodium carboxyl methyl cellulose is 6000-30000, keeps the kinetic viscosity of the heat transport medium low.

Fourth, the sodium carboxyl methyl cellulose, wherein the average molecular weight is lower, keeps the kinetic viscosity of the heat transport medium lower.

Above facts are known from the comparison of example 1-15 and comparative example 3-5.

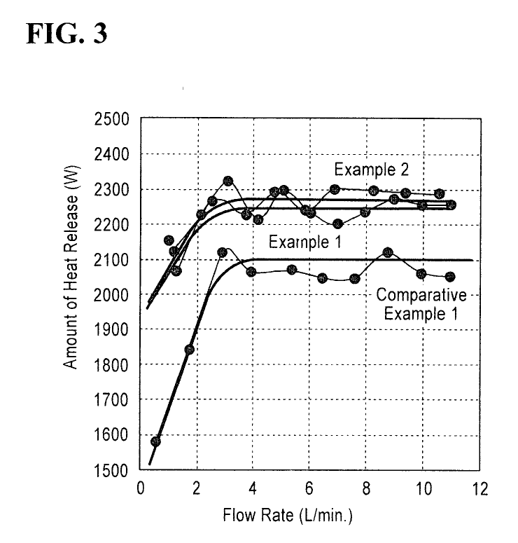

Fifth, the amount of the heat release improves by about 12%, as shown by comparing example 1, 2 with comparative example 1 in FIG. 3.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

We claim:

1. A heat transport medium comprising:
a base liquid,
carbon nanotubes and
sodium carboxyl methyl cellulose which has average molecular weight of 6000-30000 by the GPC measuring method,
wherein said carbon nanotubes and said sodium carboxyl methyl cellulose are dispersed in the base liquid.

2. The heat transport medium according to claim 1, wherein the carbon nanotubes are 0.1-10 wt % relative to the heat transport medium and the sodium carboxyl methyl cellulose is 0.1-10 wt % relative to the heat transport medium.

3. The heat transport medium according to claim 1 having kinetic viscosity less than or equal to 20 mm²/sec under 25° C. and less than or equal to 10 mm²/sec under 45° C.

4. The heat transport medium according to claim 1, wherein said carbon nanotubes and said sodium carboxyl methyl cellulose are dispersed stably in said base liquid.

5. A method of cooling an internal combustion engine in a vehicle, comprising the step of circulating the heat transport medium of claim 1.

6. A method of producing for heat transport medium including the steps of:
sending a base liquid with carbon nanotubes and a dispersant from a container to an ultrasonic processor,
dispersing the base liquid with the carbon nanotubes and the dispersant by the ultrasonic processor, and
returning the dispersed base liquid, carbon nanotubes and dispersant to the container,
wherein the above steps are repeated continuously.
